(19) United States
(12) Patent Application Publication
(10) Pub. No.: US 2026/0365899 A1
(43) Pub. Date: Nov. 19, 2026

(54) REFRIGERANT COMPOSITION COMPRISING E-1,3,3,3-TETRAFLUOROPROPENE, HYDRO(CHLORO)FLUOROCARBON AND LUBRICANT, AND REFRIGERATION, AIR-CONDITIONING OR HEAT PUMP SYSTEMS USING THE COMPOSITION

(71) Applicant: THE CHEMOURS COMPANY FC, LLC, WILMINGTON, DE (US)

(72) Inventors: SHENG PENG, HOCKESSIN, DE (US); MARIO JOSEPH NAPPA, LEESBURG, FL (US); LUKE DAVID SIMONI, WILMINGTON, DE (US)

(73) Assignee: THE CHEMOURS COMPANY FC, LLC, WILMINGTON, DE (US)

(21) Appl. No.: 19/124,967

(22) PCT Filed: Nov. 28, 2023
(86) PCT No.: PCT/US2023/081363

§ 371 Date: Apr. 28, 2025

Related U.S. Application Data
(60) Provisional application No. 63/428,510, filed on Nov. 29, 2022.

(51) Int. Cl. C09K 5/04

(52) U.S. Cl. CPC C09K 5/041; C09K 2205/102; C09K 2205/126

(57) ABSTRACT

A refrigerant composition comprising E-1,3,3,3-tetrafluoropropene, a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof, and a lubricant selected from polyol esters and polyalkylene glycols, wherein the hydro(chloro)fluorocarbon is present in the composition in a total amount of up to 1.0 wt. %, based on the total weight of the E-1,3,3,3-tetrafluoropropene and the hydro(chloro)fluorocarbon.

### CROSS REFERENCE TO RELATED APPLICATIONS

This application claims priority to U.S. Provisional Application No. 63/428,510, filed on Nov. 29, 2022, the disclosure of which is herein incorporated by reference in its entirety.

### FIELD OF THE INVENTION

The present invention relates to refrigerant compositions comprising E-1,3,3,3-tetrafluoropropene, a hydrofluorocarbon and/or a hydrochlorofluorocarbon and a lubricant. The invention particularly concerns refrigerant compositions comprising E-1,3,3,3-tetrafluoropropene (HFO-1234ze(E)), a hydro(chloro)fluorocarbon selected from 1,1,3,3-tetrafluoro-2-propene (HFO-1234zc), 1,1,1,3,3-pentafluoropropane (HFC-245fa), trans-1-chloro-3,3,3-trifluoropropene (HFO-1233zdE) and mixtures thereof, and a lubricant selected from polyol esters and polyalkylene glycols. The invention further concerns refrigeration, air-conditioning or heat pump systems using these compositions. The invention further concerns a method for reducing the viscosity of a composition comprising E-1,3,3,3-tetrafluoropropene and a lubricant, and a method for increasing the miscibility of HFO-1234ze(E) and a lubricant.

### BACKGROUND OF THE INVENTION

The fluorocarbon industry has been working for the past few decades to find replacement refrigerants for the ozone depleting chlorofluorocarbons (CFCs) and hydrochlorofluorocarbons (HCFCs) being phased out as a result of the Montreal Protocol. The solution for many applications has been the commercialization of hydrofluorocarbon (HFC) compounds for use as refrigerants, solvents, fire extinguishing agents, blowing agents and propellants. These new compounds, such as HFC refrigerants, HFC-134a and HFC-125 being the most widely used at this time, have zero ozone depletion potential and thus are not affected by the current regulatory phase-out as a result of the Montreal Protocol.

In addition to ozone depleting concerns, global warming is another environmental concern in many of these applications. Thus, there is a need for compositions that meet both low ozone depletion standards as well as having low global warming potentials. Certain hydrofluoroolefin (HFO) compositions are believed to meet both goals.

HFO-1234ze (CF₃CH═CHF), which has zero ozone depletion and low global warming potential, has been identified as a potential refrigerant meeting these goals. U.S. Pat. No. 7,862,742 discloses compositions comprising HFO-1234ze. U.S. Pat. No. 9,302,962 discloses methods for making HFO-1234ze. HFO-1234ze exists in two isomeric forms, the E-isomer and the Z-isomer. Generally, for refrigeration applications, the E-isomer is the most useful. In this application, the E-isomer is generally referred to as E-1,3,3,3-tetrafluoropropene or HFO-1234ze(E) but it is also known as trans-HFO-1234ze or HFO-1234zeE.

For use in conventional refrigeration, air-conditioning and heat pump systems comprising a compressor, the replacement refrigerants should preferably be soluble in the lubricants. If the refrigerant lacks solubility in the lubricant, there is a risk of phase separation occurring between the lubricant and the refrigerant during operation of the refrigeration or heat pump system. Phase separation, in turn, will reduce the overall performance of the system in terms of heat exchange efficiency and system lifetime. While HFO-1234ze generally is more soluble in conventional refrigeration lubricants than traditional HFCs or HCFCs, there is still a need in the art for providing refrigerants having improved solubility with refrigeration lubricants. In particular, there is a need in the art for a compatibility-improved refrigerant composition comprising a HFO-1234ze(E)-containing refrigerant and a lubricant.

### BRIEF DESCRIPTION OF THE INVENTION

The present invention meets this need by providing a refrigerant composition comprising (i) E-1,3,3,3-tetrafluoropropene, (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof, and (iii) a lubricant selected from polyol esters and polyalkylene glycols. The hydro(chloro)fluorocarbon (ii) is present in the composition in a total amount of up to 1.0 wt. %, preferably in the range of from 0.00001 wt. % to 1.0 wt. %, and more preferably from 0.0001 wt. % to 1.0 wt. %, based on the total weight of the E-1,3,3,3-tetrafluoropropene (i) and the hydro(chloro)fluorocarbon (ii).

In one embodiment, the hydro(chloro)fluorocarbon (ii) is present in the composition in a total amount in the range of from 0.001 wt. % to 0.9 wt. %, preferably from 0.005 wt. % to 0.8 wt. %, more preferably from 0.01 wt. % to 0.6 wt. %, and most preferably from 0.1 wt. % to 0.5 wt. %, based on the total weight of the E-1,3,3,3-tetrafluoropropene (i) and the hydro(chloro)fluorocarbon (ii).

One embodiment relates to any of the foregoing compositions wherein the E-1,3,3,3-tetrafluoropropene is present in the composition in an amount of 50.0 wt. % or more, preferably in an amount of 75.0 wt. % or more, more preferably in an amount of 90.0 wt. % or more, even more preferably in an amount of from 94.0 to 99.5 wt. %, and most preferably in an amount of from 94.5 to 99.0 wt. %, based on the total weight of the composition.

One embodiment relates to any of the foregoing compositions wherein the lubricant is present in the composition in an amount of 45.0 wt. % or less, preferably in an amount of 35.0 wt. % or less, more preferably in an amount of 15.0 wt. % or less, still more preferably in an amount in the range of 0.1 to 10.0 wt. %, most preferably in an amount of from 0.5 to 5.0 wt. %, based on the total weight of the composition.

One embodiment relates to any of the foregoing compositions wherein the hydro(chloro)fluorocarbon (ii) is selected from 1,1,3,3-tetrafluoro-2-propene, 1,1,1,3,3-pentafluoropropane, and a mixture thereof. In another embodiment, the hydro(chloro)fluorocarbon (ii) is 1,1,3,3-tetrafluoro-2-propene. In still another embodiment, the hydro(chloro)fluorocarbon (ii) is trans-1-chloro-3,3,3-trifluoropropene. In a further embodiment, the hydro(chloro)fluorocarbon (ii) is a mixture of 1,1,3,3-tetrafluoro-2-propene and trans-1-chloro-3,3,3-trifluoropropene, a mixture of 1,1,3,3-tetrafluoro-2-propene and 1,1,1,3,3-pentafluoropropane, or a mixture of 1,1,3,3-tetrafluoro-2-propene, 1,1,1,3,3-pentafluoropropane and trans-1-chloro-3,3,3-trifluoropropene.

One embodiment relates to any of the foregoing compositions wherein the lubricant is a polyol ester. In another embodiment, the lubricant in any of the foregoing compositions is a polyalkylene glycol.

The present disclosure further relates to a refrigeration, air-conditioning or heat pump system, comprising an evaporator, a condenser, a compressor, an expansion device, and a heat transfer medium, wherein the heat transfer medium comprises any of the foregoing compositions.

The present disclosure further relates to the use of any of the foregoing refrigerant compositions as a heat transfer medium for increasing the cooling or heating capacity in a refrigeration, air-conditioning or heat pump system comprising an evaporator, a condenser, a compressor, and an expansion device.

In the above system or use, the refrigeration, air-conditioning or heat pump system is preferably a refrigeration apparatus, an air-conditioning apparatus, a chiller apparatus, a high temperature, medium temperature or low temperature refrigeration apparatus or a high temperature, medium temperature or low temperature heat pump apparatus. It is even more preferred that any one of the above apparatuses is a stationary apparatus. Stationary air-conditioning and heat pump systems include, for example, window, ductless, ducted, packaged terminal, chillers, and light commercial and commercial air-conditioning systems, including packaged rooftop. Stationary refrigeration systems include, for example, domestic or home refrigerators and freezers, ice machines, self-contained coolers and freezers, walk-in coolers and freezers and supermarket systems.

The present disclosure further relates to a method of replacing a refrigerant composition comprising a high GWP refrigerant in a refrigeration, air-conditioning, or heat pump system, wherein the high GWP refrigerant is selected from the group consisting of R134a, R22, R123, R11, R245fa, R114, R236fa, R124, R12, R410A, R407C, R417A, R422A, R507A, R502, and R404A, the method comprising providing any of foregoing refrigerant compositions to the refrigeration, air-conditioning, or heat pump system that uses, used or is designed to use the high GWP refrigerant.

The present disclosure further relates to a method of reducing the viscosity of a refrigerant composition comprising (i) E-1,3,3,3-tetrafluoropropene and (iii) a lubricant selected from polyol esters and polyalkylene glycols, wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii), wherein the hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

The present disclosure further relates to a method of reducing the viscosity of refrigerant blends comprising (i) E-1,3,3,3-tetrafluoropropene, e.g., R-471A, R-476A, R-515A/B, and (iii) a lubricant selected from polyol esters and polyalkylene glycols, wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the R-471A, R-476A, R-482A, R-515A/B blends comprising the E-1,3,3,3-tetrafluoropropene (i) and the lubricant (iii), wherein the hydro(chloro)fluorocarbon (ii) is added in an amount such that (ii) it is present in the blend in a total amount of up to 1.0 wt. %, based on the total weight of the E-1,3,3,3-tetrafluoropropene (i) and the hydro(chloro)fluorocarbon (ii).

The present disclosure further relates to a method of reducing the viscosity of refrigerant blends comprising (i) E-1,3,3,3-tetrafluoropropene, e.g., blend No. 464A, 470A, 470B, 444A, 444B, 445A, 446A, 447A, 447B, 448A, 448B, 450A, 456A, 459A, 459B, 460A, 460B, 460C, 475A, 476A, 482A, 515A or 515B and (iii) a lubricant selected from polyol esters and polyalkylene glycols, wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to blend 464A, 470A, 470B, 444A, 444B, 445A, 446A, 447A, 447B, 448A, 448B, 450A, 456A, 459A, 459B, 460A, 460B, 460C, 475A, 476A, 482A, 515A or 515B comprising the E-1,3,3,3-tetrafluoropropene (i) and the lubricant (iii), wherein the hydro(chloro)fluorocarbon (ii) is added in an amount such that (ii) it is present in the blend in a total amount of up to 1.0 wt. %, based on the total weight of the E-1,3,3,3-tetrafluoropropene (i) and the hydro(chloro)fluorocarbon (ii).

The present disclosure also relates to a method of increasing the miscibility of (i) E-1,3,3,3-tetrafluoropropene and (iii) a lubricant selected from polyol esters and polyalkylene glycols in a refrigerant composition comprising the E-1,3,3,3-tetrafluoropropene (i) and the lubricant (iii), wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii), wherein the hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

### DETAILED DESCRIPTION OF THE INVENTION

Described are refrigerant compositions or mixtures comprising a refrigerant portion and a lubricant portion, wherein the refrigerant portion is highly miscible with the lubricant portion. More specifically, the present invention relates to a composition comprising (i) E-1,3,3,3-tetrafluoropropene, (ii) a hydrofluorocarbon and/or a hydrochlorofluorocarbon, and (iii) a lubricant. The hydro(chloro)fluorocarbon (ii) is selected from 1,1,3,3-tetrafluoro-2-propene, 1,1,1,3,3-pentafluoropropane, trans-1-chloro-3,3,3-trifluoropropene, and mixtures thereof. The lubricant (iii) is selected from polyol esters and polyalkylene glycols. The hydro(chloro)fluorocarbon (ii) is present in the composition in a total amount of up to 1.0 wt. % or in a range of more than 0 wt. % to 1.0 wt. %, based on the total weight of the E-1,3,3,3-tetrafluoropropene (ii) and the hydro(chloro)fluorocarbon (ii). Preferably, the hydro(chloro)fluorocarbon (ii) is present in the composition in a total amount in the range of from 0.00001 wt. % to 1.0 wt. %, more preferably from 0.0001 wt. % to 1.0 wt. %, and even more preferably from 0.001 to 1.0 wt. %, based on the total weight of (i) and (ii).

In a preferred embodiment, the composition comprises, consists essentially of, or consists of the E-1,3,3,3-tetrafluoropropene (i), the hydro(chloro)fluorocarbon (ii) and the lubricant (iii). When the composition consists essentially of the E-1,3,3,3-tetrafluoropropene (i), the hydro(chloro)fluorocarbon (ii) and the lubricant (iii), this means that further HFOs, hydro(chloro)fluorocarbons or lubricants are only present as unavoidable impurities, for example in an amount of less than 1000 ppm (by weight), preferably 100 ppm (by weight) or less, more preferably 10 ppm (by weight) or less, and most preferably 1 ppm (by weight) or less.

### Refrigerant

The refrigerant portion of the composition according to the invention comprises E-1,3,3,3-tetrafluoropropene (HFO-1234ze(E)).

In one embodiment, HFO-1234ze(E) can be present in the composition in a total amount of 50.0 wt. % or more, based on the total weight of the composition. In other embodiments, HFO-1234ze(E) can be present in the composition in a total amount of 60.0 wt. % or more, 65.0 wt. % or more, 70.0 wt. % or more, 75.0 wt. % or more, 80.0 wt. % or more, 85.0 wt. % or more, 90.0 wt. % or more, 95.0 wt. % or more, 96.0 wt. % or more, 97.0 wt. % or more, 98.0 wt. % or more, or 99.0 wt. % or more, based on the total weight of the composition. For example, HFO-1234ze(E) can be present in the composition in a total amount of from 50.0 wt. % to 99.5 wt. %, or from 75.0 wt. % to 99.5 wt. %, or from 90.0 wt. % to 99.5 wt. %, or from 94.0 wt. % to 99.5 wt. %, or from 94.5 wt. % to 99.5 wt. %, or from 95.0 wt. % to 99.5 wt. %; from 50.0 wt. % to 99.0 wt. %, or from 75.0 wt. % to 99.0 wt. %, or from 90.0 wt. % to 99.0 wt. %, or from 94.0 wt. % to 99.0 wt. %, or from 94.5 wt. % to 99.0 wt. %, or from 95.0 wt. % to 99.0 wt. %; from 50.0 wt. % to 96.5 wt. %, or from 75.0 wt. % to 96.5 wt. %, or from 90.0 wt. % to 96.5 wt. %, or from 94.0 wt. % to 96.5 wt. %, or from 94.5 wt. % to 96.5 wt. %, or from 95.0 wt. % to 99.0 wt. %; from 50.0 wt. % to 95.0 wt. %, or from 75.0 wt. % to 95.0 wt. %, or from 90.0 wt. % to 95.0 wt. %; from 50.0 wt. % to 90.0 wt. %, or from 75.0 wt. % to 90.0 wt. %, or from 80.0 wt. % to 90.0 wt. %, based on the total weight of the composition. In preferred embodiments, the E-1,3,3,3-tetrafluoropropene is present in the composition in an amount of 50.0 wt. % or more, preferably in an amount of 75.0 wt. % or more, more preferably in an amount of 90.0 wt. % or more, even more preferably in an amount of from 95.0 to 99.5 wt. %, and most preferably in an amount of from 95.0 to 99.0 wt. %, based on the total weight of the composition.

The refrigerant portion of the composition according to the invention further comprises a hydrofluorocarbon and/or a hydrochlorofluorocarbon (ii), also referred to herein as a hydro(chloro)fluorocarbon. The hydro(chloro)fluorocarbon is selected from 1,1,3,3-tetrafluoro-2-propene (HFO-1234zc), 1,1,1,3,3-pentafluoropropane (HFC-245fa), trans-1-chloro-3,3,3-trifluoropropene (HFO-1233zdE), and mixtures thereof.

The hydro(chloro)fluorocarbon is present in the composition in a total amount of up to 1.0 wt. %, based on the total weight of the E-1,3,3,3-tetrafluoropropene (i) and the hydro(chloro)fluorocarbon (ii). In one embodiment, the hydro(chloro)fluorocarbon is present in the composition in a total amount in the range of from 0.00001 wt. % to 1.0 wt. %, based on the total weight of the E-1,3,3,3-tetrafluoropropene (i) and the hydro(chloro)fluorocarbon (ii). In other embodiments, the hydro(chloro)fluorocarbon is present in the composition in a total amount in the range of from 0.0001 to 1.0 wt. %, preferably from 0.001 to 1.0 wt. %, from 0.01 to 1.0 wt. %, or from 0.1 to 1.0 wt. %, based on the total weight of the E-1,3,3,3-tetrafluoropropene (i) and the hydro(chloro)fluorocarbon (ii). In still other embodiments, the hydro(chloro)fluorocarbon is present in the composition in a total amount in the range of from 0.001 wt. % to 0.9 wt. %, from 0.005 wt. % to 0.8 wt. %, from 0.01 to 0.6 wt. %, or from 0.1 to 0.5 wt. %, based on the total weight of the E-1,3,3,3-tetrafluoropropene (i) and the hydro(chloro)fluorocarbon (ii).

In one embodiment, the hydro(chloro)fluorocarbon is 1,1,3,3-tetrafluoro-2-propene. In another embodiment, the hydro(chloro)fluorocarbon is 1,1,1,3,3-pentafluoropropane. In still another embodiment, the hydro(chloro)fluorocarbon is trans-1-chloro-3,3,3-trifluoropropene. In a further embodiment, the hydro(chloro)fluorocarbon is a mixture of 1,1,3,3-tetrafluoro-2-propene and 1,1,1,3,3-pentafluoropropane, or a mixture of 1,1,3,3-tetrafluoro-2-propene and trans-1-chloro-3,3,3-trifluoropropene, or a mixture of 1,1,1,3,3-pentafluoropropane and trans-1-chloro-3,3,3-trifluoropropene. In yet another embodiment, the hydro(chloro)fluorocarbon is a mixture of 1,1,3,3-tetrafluoro-2-propene, 1,1,1,3,3-pentafluoropropane and trans-1-chloro-3,3,3-trifluoropropene. In each of these embodiments, the hydro(chloro)fluorocarbon or mixture of hydro(chloro)fluorocarbons can be present in the composition in any of the above total amounts, based on the total weight of the E-1,3,3,3-tetrafluoropropene (i) and the hydro(chloro)fluorocarbon(s) (ii).

The composition of the present invention may comprise additional fluorochemicals.

In some embodiments, the composition of the invention additionally comprises one or more of HFO-1234yf, HFO-1243zf, HFO-1233zd(Z), HFO-1233xf, HFC-143a, or HFC-152a. In some embodiments, the sum total of the amounts of HFO-1234yf, HFO-1243zf, HFO-1233zd(Z), HFO-1233xf, HFC-143a, orHFC-152a is 1.0 wt. % or less, for example from 0.0001 wt. % to 1.0 wt. %, or from 0.001 to 0.5 wt. %, or from 0.001 to 0.1 wt. %, or from 0.01 to 0.05 wt. %, based on the total weight of E-1,3,3,3-tetrafluoropropene (i), the hydro(chloro)fluorocarbon (ii) and all further fluorochemicals.

In other embodiments, the composition of the invention additionally comprises one or more of HFO-1234ze(Z), HFO-1224yd, HFO-1224zc, HCFO-1326mxz, HFC-32, R-113, R-23, trifluoropropyne, HFC-356mff, and HFC-245cb, preferably one or more of HFO-1234ze(Z), trifluoropropyne, and HFC-245cb. The amount of the foregoing compounds in the composition can range from 0.0001 to 1.0 wt. %, preferably from 0.001 to 0.1 wt. %, most preferably from 0.01 to 0.05 wt. %, based on the total weight of E-1,3,3,3-tetrafluoropropene (i), the hydro(chloro)fluorocarbon (ii) and all further fluorochemicals.

In still another embodiment, the composition of the invention further comprises at least one compound selected from the group consisting of: HFC-1234ye, HFC-32, HFC-125, HFC-134, HFC-134a, HFC-143a, HFC-152a, HFC-161, HFC-227ea, HFC-236ea, HFC-236fa, HFC-365mfc, HFO-1336mzz(E), propane, n-butane, isobutane, 2-methylbutane, n-pentane, cycopentane, dimethylether, CF₃SCF₃, CO₂, CF₃I and combinations thereof. The amount of the foregoing compounds can range from 0.0001 to 1.0 wt. %, preferably from 0.001 to 0.1 wt. %, most preferably from 0.01 to 0.05 wt. %, based on the total weight of E-1,3,3,3-tetrafluoropropene (i), the hydro(chloro)fluorocarbon (ii) and the foregoing compounds.

In some embodiments the viscosity of refrigerant blends comprising (i) E-1,3,3,3-tetrafluoropropene, e.g., R-471A, R-476A, R-515A/B, and (iii) a lubricant selected from polyol esters and polyalkylene glycols is reduced, wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the R-471A, R-476A, R-482A, R-515A/B blends comprising the E-1,3,3,3-tetrafluoropropene (i) and the lubricant (iii), wherein the hydro(chloro)fluorocarbon (ii) is added in an amount such that (ii) it is present in the blend in a total amount of up to 1.0 wt. %, e.g., 0.1 wt %, 0.5 wt. % and all values between 0.1 wt. % and 1.0 wt. % based on the total weight of the E-1,3,3,3-tetrafluoropropene (i) and the hydro(chloro)fluorocarbon (ii).

In some embodiments the viscosity of refrigerant blends comprising the viscosity of refrigerant blends comprising (i) E-1,3,3,3-tetrafluoropropene, e.g., blend No. 464A, 470A, 470B, 444A, 444B, 445A, 446A, 447A, 447B, 448A, 448B, 450A, 456A, 459A, 459B, 460A, 460B, 460C, 475A, 476A, 482A, 515A or 515B and (iii) a lubricant selected from polyol esters and polyalkylene glycols is reduced, wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to blend 464A, 470A, 470B, 444A, 44B, 445A, 446A, 447A, 447B, 448A, 448B, 450A, 456A, 459A, 459B, 460A, 460B, 460C, 475A, 476A, 482A, 515A or 515B comprising the E-1,3,3,3-tetrafluoropropene (i) and the lubricant (iii), wherein the hydro(chloro)fluorocarbon (ii) is added in an amount such that (ii) it is present in the blend in a total amount of up to 1.0 wt. %, e.g., 0.1 wt. %, 0.5 wt. % and all values between 0.1 wt % and 1.0 wt. %, based on the total weight of the E-1,3,3,3-tetrafluoropropene (i) and the hydro(chloro)fluorocarbon (ii).

### Lubricant

The lubricant in the composition of the present invention is selected from polyol esters and polyalkylene glycols. In one embodiment, the lubricant is a polyol ester. In another embodiment, the lubricant is a polyalkylene glycol.

In one embodiment, the polyol esters are pentaerythritol esters of one or more linear or branched carbonic acids comprising up to 9 carbons. In a preferred embodiment, the polyol esters are pentaerythritol esters of a mixture of linear and/or branched carbonic acids comprising up to 9 carbons. Example ester substituents on the pentaerythritol main structure are heptanoate, 3,5,5-hexanoate, pentanoate, and 3-methylbutanonate. One such POE mixture is Emkarate RL32-3MAF.

In one embodiment, the polyalkylene glycols are double-capped co alkylene oxides. As the first type of synthetic lubricant oils synthesized for HFC refrigerants, they are well known as copolymer chains of alkylene oxide repeating units, typically ethylene and propylene oxides in a stoichiometric ratio. The capping end alkyl groups are terminating ether alkyl groups. Preferred are PAGs that range from ISO 32 to 68 that have linear and/or branched end capped alkyl groups (R and R′) that range from 1 to 4 carbons and have a ratio of propylene oxide (PO) to ethylene oxide (EO) repeating groups in the range from 1:3 to 3:1 according to the following formula:

RO-(EO)ₙ—(PO)ₘ—OR′

A specific PAG suitable for use as a lubricant in the present refrigerant composition is Denso ISO 46 ND-12 PAG oil.

The amount of lubricant present in the composition depends inter alia on the system in which the refrigerant system is to be used. Generally, the amount of lubricant will be selected by considering a given compressors requirements and the environment to which the lubricant will be exposed. In one embodiment, the lubricant is present in the composition in an amount of 45.0 wt. % or less, preferably in an amount of 35.0 wt. % or less, such as in an amount of 30.0 wt. % or less, 25.0 wt. % or less, 20.0 wt. % or less, 15.0 wt. % or less, 10.0 wt. % or less, or 5.0 wt. % or less, based on the total weight of the composition. For example, the lubricant may be present in the composition in an amount in the range of 0.1 to 45.0 wt. %, preferably in the range of from 0.2 to 20.0 wt. %, more preferably in the range of from 0.3 to 10.0 wt. %, still more preferably in the range of from 0.4 to 5.0 wt. %, most preferably in the range of from 0.5 to 3.5 wt. %, based on the total weight of the composition.

In a particular embodiment, the lubricant is a polyol ester and is present in the composition in an amount of 45.0 wt. % or less, preferably in an amount of 35.0 wt. % or less, such as in an amount of 30.0 wt. % or less, 25.0 wt. % or less, 20.0 wt. % or less, 15.0 wt. % or less, 10.0 wt. % or less, or 5.0 wt. % or less, based on the total weight of the composition. For example, the polyol ester lubricant may be present in the composition in an amount in the range of from 0.1 to 45.0 wt. %, preferably in the range of from 0.2 to 20.0 wt. %, more preferably in the range of from 0.3 to 10.0 wt. %, still more preferably in the range of from 0.4 to 5.0 wt. %, most preferably in the range of from 0.5 to 3.5 wt. %, based on the total weight of the composition.

In another particular embodiment, the lubricant is a polyalkylene glycol and is present in the composition in an amount of 45.0 wt. % or less, preferably in an amount of 35.0 wt. % or less, such as in an amount of 30.0 wt. % or less, 25.0 wt. % or less, 20.0 wt. % or less, 15.0 wt. % or less, 10.0 wt. % or less, or 5.0 wt. % or less, based on the total weight of the composition. For example, the polyalkylene glycol lubricant may be present in the composition in an amount in the range of from 0.1 to 45.0 wt. %, preferably in the range of from 0.2 to 20.0 wt. %, more preferably in the range of from 0.3 to 10.0 wt. %, still more preferably in the range of from 0.4 to 5.0 wt. %, most preferably in the range of from 0.5 to 3.5 wt. %, based on the total weight of the composition.

In some embodiments, the refrigerant composition comprises (i) E-1,3,3,3-tetrafluoropropene in an amount of 94.0 to 99.0 wt. %, based on the total weight of the composition, (ii) R-1233zdE in an amount of 0.001 wt. % to 1.0 wt. %, based on the total weight of (i) and (ii), and (iii) a polyol ester lubricant in an amount of 0.5 to 5.0 wt. %, based on the total weight of the composition.

In some embodiments, the refrigerant composition comprises (i) E-1,3,3,3-tetrafluoropropene in an amount of 94.0 to 99.0 wt. %, based on the total weight of the composition, (ii) R-1233zdE in an amount of 0.001 wt. % to 1.0 wt. %, based on the total weight of (i) and (ii), and (iii) a polyalkylene glycol lubricant in an amount of 0.5 to 5.0 wt. %, based on the total weight of the composition.

In some embodiments, the refrigerant composition comprises (i) E-1,3,3,3-tetrafluoropropene in an amount of 94.0 to 99.0 wt. %, based on the total weight of the composition, (ii) R-1234zc in an amount of 0.001 wt. % to 1.0 wt. %, based on the total weight of (i) and (ii), and (iii) a polyol ester lubricant in an amount of 0.5 to 5.0 wt. %, based on the total weight of the composition.

In some embodiments, the refrigerant composition comprises (i) E-1,3,3,3-tetrafluoropropene in an amount of 94.0 to 99.0 wt. %, based on the total weight of the composition, (ii) R-1234zc in an amount of 0.001 wt. % to 1.0 wt. %, based on the total weight of (i) and (ii), and (iii) a polyalkylene glycol lubricant in an amount of 0.5 to 5.0 wt. %, based on the total weight of the composition.

In some embodiments, the refrigerant composition comprises (i) E-1,3,3,3-tetrafluoropropene in an amount of 94.0 to 99.5 wt. %, based on the total weight of the composition, (ii) R-1234zc in an amount of up to 1.0 wt. %, based on the total weight of (i) and (ii), and (iii) a polyol ester lubricant in an amount of 0.1 to 5.0 wt. %, based on the total weight of the composition.

In some embodiments, the refrigerant composition comprises (i) E-1,3,3,3-tetrafluoropropene in an amount of 94.0 to 99.5 wt. %, based on the total weight of the composition, (ii) R-1234zc in an amount of up to 1.0 wt. %, based on the total weight of (i) and (ii), and (iii) a polyalkylene glycol lubricant in an amount of 0.1 to 5.0 wt. %, based on the total weight of the composition.

### Additives

Commonly used refrigeration system additives may optionally be added, as desired, to compositions of the present invention in order to enhance, e.g., lubricity and system stability. These additives are generally known within the field of refrigeration compressor lubrication, and include anti wear agents, extreme pressure lubricants, corrosion and oxidation inhibitors, metal surface deactivators, free radical scavengers, foaming and antifoam control agents, leak detectants and the like. Other additives are acid scavengers, performance enhancers and flame suppressants. In general, these additives are present only in small amounts relative to the overall composition. They are typically used at concentrations of from less than 0.1% to as much as 3% of each additive. These additives are selected on the basis of the individual system requirements. Some typical examples of such additives may include, but are not limited to, lubrication enhancing additives, such as alkyl or aryl esters of phosphoric acid and of thiophosphates. Additionally, the organometallic compound dialkyl dithiophosphates (e.g., zinc dialkyl dithiophosphate or ZDDP, Lubrizol 1375) and other members of this family of chemicals may be used in compositions of the present invention. Other antiwear additives include natural product oils and asymmetrical polyhydroxyl lubrication additives such as Synergol TMS (International Lubricants). Similarly, stabilizers such as anti-oxidants, free radical scavengers, and water scavengers may be employed. Compounds in this category can include, but are not limited to, butylated hydroxy toluene (BHT) and epoxides. An acid scavenger may comprise a siloxane, an activated aromatic compound, or a combination of both. Exemplary siloxanes that may be used include hexamethyldisiloxane, polydimethylsiloxane, polymethylphenylsiloxane, dodecamethylpentasiloxane, decamethylcyclo-pentasiloxane, decamethyltetrasiloxane, octamethyltrisiloxane, or any combination thereof. The activated aromatic compound may be any aromatic molecule activated towards a Friedel-Crafts addition reaction, or mixtures thereof. Performance Enhancers include extreme pressure additives such as mixtures of (A) tolyltriazole or substituted derivatives thereof, (B) an amine (e.g. Jeffamine M-600) and (C) a third component which is (i) an ethoxylated phosphate ester (e.g. Antara LP-700 type), or (ii) a phosphate alcohol (e.g. ZELEC 3337 type), or (iii) a Zinc dialkyldithiophosphate (e.g. Lubrizol 5139, 5604, 5178, or 5186 type), or (iv) a mercaptobenzothiazole, or (v) a 2,5-dimercapto-1,3,4-tiadiazole derivative (e. g. Curvan 826) or a mixture thereof.

The compositions of the present invention may further comprise a compatibilizer selected from the group consisting of polyoxyalkylene glycol ethers, amides, nitriles, ketones, chlorocarbons, esters, lactones, aryl ethers, fluoroethers and 1,1,1-trifluoroalkanes. Such compatibilizers are preferably present in amounts of up to 3.0 wt. %, for example in an amount of 0.01 to 2.0 by weight of the composition.

The refrigerant compositions of the present invention may be prepared by combining the E-1,3,3,3-tetrafluoropropene, the hydro(chloro)fluorocarbon(s), the lubricant and any optional components in the desired amounts. In one embodiment, the refrigerant composition may be prepared by a method comprising weighing the desired component amounts and thereafter combining the components in an appropriate vessel, preferably by using agitation. In a further embodiment, the refrigerant composition may be prepared by a method comprising (i) reclaiming a volume of one or more components of the refrigerant composition from at least one container, (ii) removing impurities sufficiently to enable reuse of the one or more of the reclaimed components, and (iii) optionally, combining all or part of the reclaimed volume of components with at least one additional refrigerant composition or component.

The refrigerant composition may be useful in various applications. In an embodiment, any of the foregoing refrigerant compositions may be used as a replacement for older generation refrigerant compositions (such as, for example, R-404A, or R-502, etc.) to provide a more environmentally friendly composition. The refrigerant composition of the invention may be used to replace at least a portion of the older generation refrigerant composition. Preferably, the refrigerant composition of the invention may be used to replace all or substantially all of the older generation refrigerant composition.

Accordingly, the invention further relates to a method of replacing at least a portion, preferably all or substantially all, of a refrigerant composition comprising a high GWP refrigerant in a refrigeration, air-conditioning or heat pump system, preferably a refrigeration or air-conditioning system, more preferably an air-conditioning system, most preferably a stationary air-conditioning system, wherein the high GWP refrigerant is selected from the group consisting of R134a, R22, R123, R11, R245fa, R114, R236fa, R124, R12, R410A, R407C, R417A, R422A, R507A, R502, and R404A, the method comprising providing the composition of the invention to the refrigeration, air-conditioning or heat pump system that uses, used or is designed to use the high GWP refrigerant.

In one embodiment, said method is a method of replacing at least a portion, preferably all or substantially all, of a refrigerant composition comprising a high GWP refrigerant in a refrigeration, air-conditioning or heat pump system, preferably a refrigeration or air-conditioning system, more preferably an air-conditioning system, most preferably a stationary air-conditioning system, wherein the high GWP refrigerant is selected from the group consisting of R22, R410A, R407C, and R417A.

In a preferred embodiment, said method is a method of replacing substantially all of a refrigerant composition comprising a high GWP refrigerant in a stationary air-conditioning system, wherein the high GWP refrigerant is selected from the group consisting of R22, R410A, R407C, and R417A, and preferably is R410A.

In some embodiments, the refrigerant composition of the present invention may be used as a heat transfer medium for increasing the cooling or heating capacity in a refrigeration, air-conditioning or heat pump system comprising an evaporator, a condenser, a compressor and an expansion device. Preferably, the refrigeration, air-conditioning or heat pump system is a refrigeration apparatus, an air-conditioning apparatus, a chiller apparatus, a high temperature, medium temperature or low temperature refrigeration apparatus or heat pump. In one preferred embodiment, the foregoing refrigerant compositions are used as a heat transfer medium in a stationary refrigeration apparatus, a stationary air-conditioning apparatus, a stationary chiller apparatus, a stationary high temperature, medium temperature or low temperature refrigeration apparatus or heat pump.

The present invention further relates to a refrigeration, air-conditioning or heat pump system, comprising an evaporator, a condenser, a compressor, an expansion device, and a heat transfer medium, wherein the heat transfer medium comprises the refrigerant composition of the present invention. The refrigeration, air-conditioning or heat pump system preferably is a refrigeration apparatus, an air-conditioning apparatus, a chiller apparatus, a high temperature, medium temperature or low temperature refrigeration apparatus or heat pump, and most preferably a stationary refrigeration apparatus, a stationary air-conditioning apparatus, a stationary chiller apparatus, a stationary high temperature, medium temperature or low temperature refrigeration apparatus or heat pump.

In the refrigerant composition of the present invention comprising E-1,3,3,3-tetrafluoropropene and the hydro(chloro)fluorocarbon as described above, the refrigerant demonstrates greater solubility in POE and PAG oil in the liquid phase, compared to E-1,3,3,3-tetrafluoropropene without the hydro(chloro)fluorocarbon. As a result, the refrigerant composition is less viscous and mobility is increased.

Accordingly, the present invention further relates to a method of reducing the viscosity of a refrigerant composition comprising (i) E-1,3,3,3-tetrafluoropropene and (iii) a lubricant selected from polyol esters and polyalkylene glycols. The method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii). The hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

One embodiment of said method of reducing the viscosity of the refrigerant composition is a method wherein the hydro(chloro)fluorocarbon (ii) is added in an amount such that (ii) is present in the composition in a total amount in the range of from 0.00001 wt. % to 1.0 wt. %, preferably from 0.0001 wt. % to 1.0 wt. %, more preferably from 0.001 wt. % to 0.9 wt. %, still more preferably from 0.005 wt. % to 0.8 wt. %, even more preferably from 0.01 wt. % to 0.6 wt. %, and most preferably from 0.1 to 0.5 wt. %, based on the total weight of the E-1,3,3,3-tetrafluoropropene (i) and the hydro(chloro)fluorocarbon (ii).

A further embodiment of any of the above methods of reducing the viscosity of the refrigerant composition is a method wherein the E-1,3,3,3-tetrafluoropropene is present in the composition in an amount of 50.0 wt. % or more, preferably in an amount of 75.0 wt. % or more, more preferably in an amount of 90.0 wt. % or more, even more preferably in an amount of from 94.0 to 99.5 wt. %, most preferably in an amount of from 94.5 to 99.0 wt. %, based on the total weight of the composition after the hydro(chloro)fluorocarbon (ii) has been added.

A further embodiment of any of the above methods of reducing the viscosity of the refrigerant composition is a method wherein the lubricant is present in the composition in an amount of 45.0 wt. % or less, preferably in an amount of 35.0 wt. % or less, more preferably in an amount of 15.0 wt. % or less, still more preferably in an amount in the range of 0.1 to 10.0 wt. %, most preferably in an amount of from 0.5 to 5.0 wt. %, based on the total weight of the composition after the hydro(chloro)fluorocarbon (ii) has been added.

A further embodiment of any of the above methods of reducing the viscosity of the refrigerant composition is a method wherein the hydro(chloro)fluorocarbon (ii) is selected from 1,1,3,3-tetrafluoro-2-propene, 1,1,1,3,3-pentafluoropropane, and a mixture thereof, or wherein the hydro(chloro)fluorocarbon (ii) is 1,1,3,3-tetrafluoro-2-propene, or wherein the hydro(chloro)fluorocarbon (ii) is trans-1-chloro-3,3,3-trifluoropropene, or wherein the hydro(chloro)fluorocarbon (ii) is a mixture of 1,1,3,3-tetrafluoro-2-propene and trans-1-chloro-3,3,3-trifluoropropene, a mixture of 1,1,3,3-tetrafluoro-2-propene and 1,1,1,3,3-pentafluoropropane, or a mixture of 1,1,3,3-tetrafluoro-2-propene, 1,1,1,3,3-pentafluoropropane and trans-1-chloro-3,3,3-trifluoropropene.

In a specific embodiment of any of the above methods of reducing the viscosity of the refrigerant composition, the lubricant is a polyol ester, preferably a pentaerythritol ester of one or more linear or branched carbonic acids comprising up to 9 carbons, more preferably wherein the polyol ester is a pentaerythritol ester of a mixture of linear and/or branched carbonic acids comprising up to 9 carbons. In a further specific embodiment, the lubricant is a polyalkylene glycol, preferably a double-capped co-alkylene oxide having copolymer chains of alkylene oxide repeating units and ether alkyl capping groups.

The present disclosure also relates to a method of increasing the miscibility of (i) E-1,3,3,3-tetrafluoropropene and (iii) a lubricant selected from polyol esters and polyalkylene glycols in a refrigerant composition comprising the E-1,3,3,3-tetrafluoropropene (i) and the lubricant (iii). The method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii). The hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

One embodiment of said method of increasing the miscibility of E-1,3,3,3-tetrafluoropropene and the lubricant is a method wherein the hydro(chloro)fluorocarbon (ii) is added in an amount such that (ii) is present in the composition in a total amount in the range of from 0.00001 wt. % to 1.0 wt. %, preferably from 0.0001 wt. % to 1.0 wt. %, more preferably from 0.001 wt. % to 0.9 wt. %, still more preferably from 0.005 wt. % to 0.8 wt. %, even more preferably from 0.01 wt. % to 0.6 wt. %, and most preferably from 0.1 to 0.5 wt. %, based on the total weight of the E-1,3,3,3-tetrafluoropropene (i) and the hydro(chloro)fluorocarbon (ii).

A further embodiment of any of the above methods of increasing the miscibility of E-1,3,3,3-tetrafluoropropene and the lubricant is a method wherein the E-1,3,3,3-tetrafluoropropene is present in the composition in an amount of 50.0 wt. % or more, preferably in an amount of 75.0 wt. % or more, more preferably in an amount of 90.0 wt. % or more, even more preferably in an amount of from 94.0 to 99.5 wt. %, most preferably in an amount of from 94.5 to 99.0 wt. %, based on the total weight of the composition after the hydro(chloro)fluorocarbon (ii) has been added.

A further embodiment of any of the above methods of increasing the miscibility of E-1,3,3,3-tetrafluoropropene and the lubricant is a method wherein the lubricant is present in the composition in an amount of 45.0 wt. % or less, preferably in an amount of 35.0 wt. % or less, more preferably in an amount of 15.0 wt. % or less, still more preferably in an amount in the range of 0.1 to 10.0 wt. %, most preferably in an amount of from 0.5 to 5.0 wt. %, based on the total weight of the composition after the hydro(chloro)fluorocarbon (ii) has been added.

A further embodiment of any of the above methods of increasing the miscibility of E-1,3,3,3-tetrafluoropropene and the lubricant is a method wherein the hydro(chloro)fluorocarbon (ii) is selected from 1,1,3,3-tetrafluoro-2-propene, 1,1,1,3,3-pentafluoropropane, and a mixture thereof, or wherein the hydro(chloro)fluorocarbon (ii) is 1,1,3,3-tetrafluoro-2-propene, or wherein the hydro(chloro)fluorocarbon (ii) is trans-1-chloro-3,3,3-trifluoropropene, or wherein the hydro(chloro)fluorocarbon (ii) is a mixture of 1,1,3,3-tetrafluoro-2-propene and trans-1-chloro-3,3,3-trifluoropropene, a mixture of 1,1,3,3-tetrafluoro-2-propene and 1,1,1,3,3-pentafluoropropane, or a mixture of 1,1,3,3-tetrafluoro-2-propene, 1,1,1,3,3-pentafluoropropane and trans-1-chloro-3,3,3-trifluoropropene.

In a specific embodiment of any of the above methods of increasing the miscibility of E-1,3,3,3-tetrafluoropropene and the lubricant, the lubricant is a polyol ester, preferably a pentaerythritol ester of one or more linear or branched carbonic acids comprising up to 9 carbons, more preferably wherein the polyol ester is a pentaerythritol ester of a mixture of linear and/or branched carbonic acids comprising up to 9 carbons. In a further specific embodiment, the lubricant is a polyalkylene glycol, preferably a double-capped co-alkylene oxide having copolymer chains of alkylene oxide repeating units and ether alkyl capping groups.

The present disclosure also relates to a method of increasing the solubility of (i) E-1,3,3,3-tetrafluoropropene in (iii) a lubricant selected from polyol esters and polyalkylene glycols in a refrigerant composition comprising the E-1,3,3,3-tetrafluoropropene (i) and the lubricant (iii), wherein the method comprises the addition of (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii), wherein the hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

One embodiment of said method of increasing the solubility of E-1,3,3,3-tetrafluoropropene in the lubricant is a method wherein the hydro(chloro)fluorocarbon (ii) is added in an amount such that (ii) is present in the composition in a total amount in the range of from 0.00001 wt. % to 1.0 wt. %, preferably from 0.0001 wt. % to 1.0 wt. %, more preferably from 0.001 wt. % to 0.9 wt. %, still more preferably from 0.005 wt. % to 0.8 wt. %, even more preferably from 0.01 wt. % to 0.6 wt. %, and most preferably from 0.1 to 0.5 wt. %, based on the total weight of the E-1,3,3,3-tetrafluoropropene (i) and the hydro(chloro)fluorocarbon (ii).

A further embodiment of any of the above methods of increasing the solubility of E-1,3,3,3-tetrafluoropropene in the lubricant is a method wherein the E-1,3,3,3-tetrafluoropropene is present in the composition in an amount of 50.0 wt. % or more, preferably in an amount of 75.0 wt. % or more, more preferably in an amount of 90.0 wt. % or more, even more preferably in an amount of from 94.0 to 99.5 wt. %, most preferably in an amount of from 94.5 to 99.0 wt. %, based on the total weight of the composition after the hydro(chloro)fluorocarbon (ii) has been added.

A further embodiment of any of the above methods of increasing the solubility of E-1,3,3,3-tetrafluoropropene in the lubricant is a method wherein the lubricant is present in the composition in an amount of 45.0 wt. % or less, preferably in an amount of 35.0 wt. % or less, more preferably in an amount of 15.0 wt. % or less, still more preferably in an amount in the range of 0.1 to 10.0 wt. %, most preferably in an amount of from 0.5 to 5.0 wt. %, based on the total weight of the composition after the hydro(chloro)fluorocarbon (ii) has been added.

A further embodiment of any of the above methods of increasing the solubility of E-1,3,3,3-tetrafluoropropene in the lubricant is a method wherein the hydro(chloro)fluorocarbon (ii) is selected from 1,1,3,3-tetrafluoro-2-propene, 1,1,1,3,3-pentafluoropropane, and a mixture thereof, or wherein the hydro(chloro)fluorocarbon (ii) is 1,1,3,3-tetrafluoro-2-propene, or wherein the hydro(chloro)fluorocarbon (ii) is trans-1-chloro-3,3,3-trifluoropropene, or wherein the hydro(chloro)fluorocarbon (ii) is a mixture of 1,1,3,3-tetrafluoro-2-propene and trans-1-chloro-3,3,3-trifluoropropene, a mixture of 1,1,3,3-tetrafluoro-2-propene and 1,1,1,3,3-pentafluoropropane, or a mixture of 1,1,3,3-tetrafluoro-2-propene, 1,1,1,3,3-pentafluoropropane and trans-1-chloro-3,3,3-trifluoropropene.

In a specific embodiment of any of the above methods of increasing the solubility of E-1,3,3,3-tetrafluoropropene and the lubricant, the lubricant is a polyol ester, preferably a pentaerythritol ester of one or more linear or branched carbonic acids comprising up to 9 carbons, more preferably wherein the polyol ester is a pentaerythritol ester of a mixture of linear and/or branched carbonic acids comprising up to 9 carbons. In a further specific embodiment, the lubricant is a polyalkylene glycol, preferably a double-capped co-alkylene oxide having copolymer chains of alkylene oxide repeating units and ether alkyl capping groups.

In the methods of reducing the viscosity of the refrigerant composition or increasing the miscibility of E-1,3,3,3-tetrafluoropropene and the lubricant or increasing the solubility of E-1,3,3,3-tetrafluoropropene in the lubricant described above, the refrigerant composition obtained after the hydro(chloro)fluorocarbon (ii) has been added may also comprise the HFO-1234ze(E), the lubricant, optional co-refrigerants as well as optional additives as described above in the sections “Refrigerant”, “Lubricant” and “Additives”.

### EXAMPLES

The invention described herein will be further described in the following examples, which do not limit the scope of the invention described in the claims.

### Example 1

The solubility in POE and PAG lubricant oils of E-1,3,3,3-tetrafluoropropene was compared to that of mixtures of E-1,3,3,3-tetrafluoropropene with various hydro(chloro)fluorocarbons.

For calculating solubility, the method by Charles Hansen [Hansen, Charles (2007). Hansen Solubility Parameters: A users handbook, Second Edition] was used. Hansen solubility parameters (HSPs) are a way of predicting if one material will dissolve in another and form a solution. They are based on the idea that similar molecules dissolve chemically similar molecules. That is, a molecule is defined as being “like” another molecule if it interacts with itself in a similar way. HSPs are a decomposition of the total Hildebrand solubility parameter which is a direct function of a material's cohesive energy. This is directly related to the energy of vaporization of the material in question. The total solubility parameter can be decomposed into dispersion, polar and association intermolecular force-based contributions. Every material can be represented in this 3-dimensional solubility parameter space with coordinates (δ_{D}, δ_{P}, δ_{H}), such that the distance between any two materials solubility loci represents how compatible that they are in terms of solubility.

Hansen Solubility Parameters were determined by using the software Hansen Solubility Parameters In Practice (HSPiP) v5.4.02 [available from Digital River GmbH, Cologne, Germany]. Using this program, the HSPs (δ_{D}, δ_{P}, δ_{H}) for POE and PAG lubricant oils as well as for HFO-1234ze(E) and various other hydrofluorocarbon and hydrochlorofluorocarbon refrigerant components were determined with the well-known Yamamoto-Molecular Break GCM/QSAR method and are listed in Table 1.

TABLE 1

| | | | δH |
|---|---|---|---|
| | δD (MPa²) | δP (MPa²) | (MPa²) |
| POE | 16.48 | 2.25 | 2.77 |
| PAG | 15.89 | 4.52 | 4.78 |
| R-1234zeE | 14.04 | 2.93 | 2.88 |
| R-1234zc | 14.53 | 3.55 | 2.55 |
| R-1243zf | 13.76 | 3.11 | 2.74 |
| R-1234yf | 13.26 | 2.92 | 1.76 |
| R-245fa | 14.27 | 3.72 | 2.43 |
| R-1233zdE | 15.39 | 3.50 | 2.82 |

The relative distances (Ra) from each refrigerant component to each oil were then calculated as

Ra²=4(δ_{D,oil}−δ_{D,refrigerant})²+(δ_{P,oil}−δ_{P,refrigerant})²+(δ_{H,oil}−δ_{H,refrigerant})² (1)

These are listed in Table 2.

TABLE 2

| | POE | PAG |
|---|---|---|
| | Ra | Ra |
| R-1234zeE | 4.92 | 4.45 |
| R-1234zc | 4.11 | 3.65 |
| R-1243zf | 5.50 | 4.93 |
| R-1234yf | 6.55 | 6.27 |
| R-245fa | 4.67 | 4.08 |
| R-1233zdE | 2.51 | 2.43 |

The relative distances Ra are a measure to determine the solubility of a component in the respective oil. In particular, the smaller the distance of the hydrofluorocarbon component to each oil, the better its solubility in the oil. As can be seen from Table 2, each of R-1234zc, R-245fa and R-1233zdE has a smaller distance to POE than R-1234zeE. Similarly, each of R-1234zc, R-245fa and R-1233zdE has a smaller distance to PAG than R-1234zeE.

Hence, the solubility of a R-1234zeE refrigerant is enhanced by additions of R-1234zc, R-245fa and/or R-1233zdE in both POE and PAG oil. For example, in both oils, adding 1 wt. % of R-1234zc to pure R-1234ze decreases the distance described in equation (1) above, thereby decreasing Gibbs free energy of mixing, which increases the refrigerants solubility in the lubricants. Likewise, adding a small amount of each of R-1234zc, R-245fa and R-1233zdE to R-1234zeE, for example such that the resultant composition is 99.4 wt. % R-1234zeE, 0.2 wt. % R-1234zc, 0.2 wt. % R-245fa, and 0.2 wt. % R-1233zdE renders the resultant mixture to be more soluble in POE or PAG oil than the original R-1234zeE fluid.

The enhanced solubility improves the mobility of the lubricant through the air conditioning and heat pump circuits, which enhances oil return to the compressor sump. This provides for better lubricity between moving parts in the compressor, increasing their life span, as well as ameliorating the reduction of the overall heat transfer coefficient in the evaporator, thus avoiding cooling capacity degradation.

Table 3 lists the percent improvement in solubility in terms of distance reduction for R-1234zc, R-245fa or R-1233zdE added to R-1234zeE.

As an example, the addition of 1 wt. % of R-1233zdE “pulls” the HSP locus of R-1234zeE towards that of PAG oil. This decreases the Gibbs free energy of mixing and renders the refrigerant more soluble and therefore less viscous. As a result, mobility is increased. Moreover, while these results were determined at 25 °C, the improvement in solubility is even more pronounced at colder temperatures, such as those during a cold winter season startup, which further demonstrates the great potential of the present invention.

Improvements in solubility were also found when adding certain hydro(chloro)fluorocarbons at 0.5 wt. % and 0.1 wt. % levels as shown in Tables 4-5 below.

TABLE 4
R-1234zeE with 0.5% of additional molecule

| | | | | | | 0.5% of X in R-1234zeE | | | |
|---|---|---|---|---|---|---|---|---|---|
| | δ_{D} | δ_{P} | δ_{H} | Distance | | POE | | PAG | |
| | (MPa²) | (MPa²) | (MPa²) | POE | PAG | blend D | % dev D | blend D | % dev D |
| POE | 16.48 | 2.25 | 2.77 | | | | | | |
| PAG | 15.89 | 4.52 | 4.78 | | | | | | |
| R-1234yf | 13.26 | 2.92 | 1.76 | 6.5482128 | 6.271799 | 4.931511 | 0.16427549 | 4.461058 | 0.212703053 |
| R-1234zeE | 14.04 | 2.93 | 2.88 | 4.9234234 | 4.4515891 | | | | |
| HCFO-1233xf | 14.68 | 3.48 | 1.75 | 3.9336815 | 4.015758 | 4.916269 | −0.145314435 | 4.447034 | −0.102322594 |
| R-1234zc | 14.53 | 3.55 | 2.55 | 4.1116801 | 3.6484329 | 4.919379 | −0.082147337 | 4.447538 | −0.091006547 |
| R-1243zf | 13.76 | 3.11 | 2.74 | 5.5026549 | 4.9278372 | 4.926308 | 0.058591736 | 4.453896 | 0.05181816 |
| R-245fa | 14.27 | 3.72 | 2.43 | 4.6652706 | 4.0812718 | 4.921604 | −0.036960105 | 4.449184 | −0.054036206 |
| R-1233zdE | 15.39 | 3.5 | 2.82 | 2.5082452 | 2.4269314 | 4.909747 | −0.277786972 | 4.438846 | −0.286267225 |

TABLE 5
R1234zeE with 0.1% of additional molecule

| | | | | 0.1% of X in R-1234zeE | | | | | |
|---|---|---|---|---|---|---|---|---|---|
| | δ_{D} | δ_{P} | δ_{H} | Distance | | POE | | PAG | |
| | (MPa²) | (MPa²) | (MPa²) | POE | PAG | blend D | % dev D | blend D | % dev D |
| POE | 16.48 | 2.25 | 2.77 | | | | | | |
| PAG | 15.89 | 4.52 | 4.78 | | | | | | |
| R-1234yf | 13.26 | 2.92 | 1.76 | 6.5482128 | 6.271799 | 4.925041 | 0.032850752 | 4.453483 | 0.042545693 |
| R-1234zeE | 14.04 | 2.93 | 2.88 | 4.9234234 | 4.4515891 | 4.923423 | 0.00E+00 | 4.451589 | 0.00E+00 |
| HCFO-1233xf | 14.68 | 3.48 | 1.75 | 3.9336815 | 4.015758 | 4.921991 | −0.029103433 | 4.450676 | −0.020515686 |
| R-1234zc | 14.53 | 3.55 | 2.55 | 4.1116801 | 3.6484329 | 4.922615 | −0.016427766 | 4.450779 | −0.018199918 |
| R-1243zf | 13.76 | 3.11 | 2.74 | 5.5026549 | 4.9278372 | 4.924 | 0.011718131 | 4.45205 | 0.010362135 |
| R-245fa | 14.27 | 3.72 | 2.43 | 4.6652706 | 4.0812718 | 4.923059 | −0.007400497 | 4.451108 | −0.010816762 |
| R-1233zdE | 15.39 | 3.5 | 2.82 | 2.5082452 | 2.4269314 | 4.920687 | −0.05557744 | 4.449039 | −0.057285616 |

One embodiment relates to a refrigerant composition comprising, (i) an E-1,3,3,3-tetrafluoropropene blend selected from one of 464A, 470A, 470B, 444A, 444B, 445A, 446A, 447A, 447B, 448A, 448B, 450A, 456A, 459A, 459B, 460A, 460B, 460C, 475A, 476A, 482A, 515A or 515B, (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof, and (iii) a lubricant selected from polyol esters and polyalkylene glycols, wherein the hydro(chloro)fluorocarbon (ii) is present in the composition in a total amount of up to 1.0 wt. %, based on the total weight of the E-1,3,3,3-tetrafluoropropene (i) and the hydro(chloro)fluorocarbon (ii).

One embodiment relates to a refrigerant composition comprising, (i) an E-1,3,3,3-tetrafluoropropene blend selected from one of 464A, 470A, 470B, 444A, 444B, 445A, 446A, 447A, 447B, 448A, 448B, 450A, 456A, 459A, 459B, 460A, 460B, 460C, 475A, 476A, 482A, 515A or 515B, (ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof, and (iii) a lubricant selected from polyol esters and polyalkylene glycols, wherein the hydro(chloro)fluorocarbon (ii) is present in the composition in a total amount in a range selected from one of: from 0.00001 wt. % to 1.0 wt. %, from 0.0001 wt. % to 1.0 wt. %, from 0.001 wt. % to 0.9 wt. %, 0.005 wt. % to 0.8 wt. %, from 0.01 wt. % to 0.6 wt. %, from 0.1 to 0.5 wt. %, from 0.5 wt. % to ≤1 wt. % based on the total weight of the E-1,3,3,3-tetrafluoropropene (i) and the hydro(chloro)fluorocarbon (ii).

1. A refrigerant composition comprising
(i) E-1,3,3,3-tetrafluoropropene,
(ii) a hydro(chloro)fluorocarbon selected from 1,1,3,3-tetrafluoro-2-propene, 1,1,1,3,3-pentafluoropropane, trans-1-chloro-3,3,3-trifluoropropene, and mixtures thereof, and
(iii) a lubricant selected from polyol esters and polyalkylene glycols,
wherein the hydro(chloro)fluorocarbon (ii) is present in the composition in a total amount of up to 1.0 wt. %, based on the total weight of the E-1,3,3,3-tetrafluoropropene (i) and the hydro(chloro)fluorocarbon (ii).

2. The composition of claim 1, wherein the hydro(chloro)fluorocarbon (ii) is present in the composition in a total amount in the range of from 0.00001 wt. % to 1.0 wt. %, based on the total weight of the E-1,3,3,3-tetrafluoropropene (i) and the hydro(chloro)fluorocarbon (ii).

3. The composition of claim 1, wherein the E-1,3,3,3-tetrafluoropropene is present in the composition in an amount of 50.0 wt. % or more, based on the total weight of the composition.

4. The composition of claim 1, wherein the lubricant is present in the composition in an amount of 45.0 wt. % or less, based on the total weight of the composition.

5. The composition of claim 1, wherein the hydro(chloro)fluorocarbon (ii) is selected from the group consisting of 1,1,3,3-tetrafluoro-2-propene, 1,1,1,3,3-pentafluoropropane, and a mixture thereof, or wherein the hydro(chloro)fluorocarbon (ii) is 1,1,3,3-tetrafluoro-2-propene, or wherein the hydro(chloro)fluorocarbon (ii) is trans-1-chloro-3,3,3-trifluoropropene.

6. The composition of claim 1, wherein the hydro(chloro)fluorocarbon (ii) is a mixture of 1,1,3,3-tetrafluoro-2-propene and trans-1-chloro-3,3,3-trifluoropropene, a mixture of 1,1,3,3-tetrafluoro-2-propene and 1,1,1,3,3-pentafluoropropane, or a mixture of 1,1,3,3-tetrafluoro-2-propene, 1,1,1,3,3-pentafluoropropane and trans-1-chloro-3,3,3-trifluoropropene.

7. The composition of claim 1, wherein the lubricant is a polyol ester.

8. The composition of claim 7, wherein the polyol ester is a pentaerythritol ester of one or more linear or branched carbonic acids comprising up to 9 carbons.

9. The composition of claim 1, wherein the lubricant is a polyalkylene glycol.

10. The composition of claim 9, wherein the polyalkylene glycol is a double-capped co-alkylene oxide having copolymer chains of alkylene oxide repeating units and ether alkyl capping groups.

11. A refrigeration, air-conditioning or heat pump system, comprising an evaporator, a condenser, a compressor, an expansion device, and a heat transfer medium, wherein the heat transfer medium comprises the refrigerant composition of claim 1.

12. (canceled)

13. A method of replacing a refrigerant composition comprising a high GWP refrigerant in a refrigeration, air-conditioning, or heat pump system, wherein the high GWP refrigerant is selected from the group consisting of R-134a, R-22, R-123, R-11, R-245fa, R-114, R-236fa, R-124, R-12, R-410A, R-407C, R-417A, R-422A, R-507A, R-502, and R-404A, the method comprising providing the composition of claim 1 to the refrigeration, air-conditioning, or heat pump system that uses, used or is designed to use the high GWP refrigerant.

14. A method comprising:
providing a refrigerant composition comprising (i) E-1,3,3,3-tetrafluoropropene and (iii) a lubricant selected from the group consisting of polyol esters and polyalkylene glycols, and
adding (ii) a hydro(chloro)fluorocarbon selected from the group consisting of 1,1,3,3-tetrafluoro-2-propene, 1,1,1,3,3-pentafluoropropane, trans-1-chloro-3,3,3-trifluoropropene, and mixtures thereof to the composition comprising the E-1,3,3,3-tetrafluoropropene (i) and the lubricant (iii), wherein the hydro(chloro)fluorocarbon (ii) is added in an amount such that (ii) is present in the composition in a total amount of up to 1.0 wt. %, based on the total weight of the E-1,3,3,3-tetrafluoropropene (i) and the hydro(chloro)fluorocarbon (ii).

15. The method of claim 14, wherein the method reduces the viscosity or increases the miscibility of the refrigerant composition comprising the E-1,3,3,3-tetrafluoropropene and the lubricant.

16. A refrigerant composition comprising
(i) an E-1,3,3,3-tetrafluoropropene blend selected from the group consisting of R464A, R-470A, R-470B, R-444A, R-444B, R-445A, R-446A, R-447A, R-447B, R-448A, R-448B, R-450A, R-456A, R-459A, R-459B, R-460A, R-460B, R-460C, R-475A, R-476A, R-482A, R-515A or R-515B,
(ii) a hydro(chloro)fluorocarbon selected from the group consisting of 1,1,3,3-tetrafluoro-2-propene, 1,1,1,3,3-pentafluoropropane, trans-1-chloro-3,3,3-trifluoropropene, and mixtures thereof, and
(iii) a lubricant selected from the group consisting of polyol esters and polyalkylene glycols,
wherein the hydro(chloro)fluorocarbon (ii) is present in the composition in a total amount of up to 1.0 wt. %, based on the total weight of the E-1,3,3,3-tetrafluoropropene (i) and the hydro(chloro)fluorocarbon (ii).

17. The composition of claim 16, wherein the hydro(chloro)fluorocarbon (ii) is present in the composition in a total amount in a range selected from one of: from 0.00001 wt. % to 1.0 wt. %, from 0.0001 wt. % to 1.0 wt. %, from 0.001 wt. % to 0.9 wt. %, 0.005 wt. % to 0.8 wt. %, from 0.01 wt. % to 0.6 wt. %, from 0.1 to 0.5 wt. %, from 0.5 wt. % to ≤1 wt. % based on the total weight of the E-1,3,3,3-tetrafluoropropene (i) and the hydro(chloro)fluorocarbon (ii).

18. The refrigeration, air-conditioning or heat pump system of claim 11, wherein the refrigeration, air-conditioning or heat pump system is selected from the group consisting of a refrigeration apparatus, an air-conditioning apparatus, a chiller apparatus, a high temperature refrigeration apparatus, a medium temperature refrigeration apparatus, a low temperature refrigeration apparatus, a high temperature heat pump, a medium temperature heat pump and a low temperature heat pump.

19. The refrigeration, air-conditioning or heat pump system of claim 11, wherein the refrigeration, air-conditioning or heat pump system is selected from the group consisting of a stationary refrigeration apparatus, a stationary air-conditioning apparatus, a stationary chiller apparatus, a stationary high temperature refrigeration apparatus, a stationary medium temperature refrigeration apparatus, a stationary low temperature refrigeration apparatus, a stationary high temperature heat pump, a stationary medium temperature heat pump and a stationary low temperature heat pump.
